(19) United States
(12) Patent Application Publication
(10) Pub. No.: US 2024/0111352 A1
(43) Pub. Date: Apr. 4, 2024

(54) PAUSING OR HANDING OFF A NAVIGATION SESSION TO SAVE POWER

(71) Applicant: GOOGLE LLC, Mountain View, CA (US)

(72) Inventors: Matthew Sharifi; Victor Carbune, Zurich (CH)

(21) Appl. No.: 17/637,989

(22) PCT Filed: Jul. 19, 2021
(86) PCT No.: PCT/US21/42177

§ 371 Date: Jan. 26, 2023

(51) Int. Cl. G06F 1/3212; G01C 21/36

(52) U.S. Cl. CPC G06F 1/3212; G01C 21/3667; G01C 21/3691

(57) ABSTRACT

Techniques for saving mobile device power during turn by turn navigation sessions are provided. An example method includes receiving an indication of an origin location and a destination location via a navigation application operating on a mobile computing device; generating a navigation route based on the origin location and the destination location using the navigation application, including indications of one or more maneuvers required to be performed by a user; comparing a remaining battery power level associated with the mobile computing device to a predicted processing power required for the navigation application to perform one or more functions related to the navigation route; and causing the navigation application to operate in a power-saving mode based on the comparison. Operating the navigation application in the power-saving mode may include temporarily suspending at least one of the one or more functions of related to the navigation route.

### FIELD OF THE DISCLOSURE

The present disclosure generally relates to turn by turn navigation and, more particularly, to saving power during a navigation session.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Turn by turn navigation is a frequently used method for reaching a pre-programmed destination by driving or other modes of transportation, such as walking, cycling, public transit, etc. In current navigation setups, the session is considered to be active for the entire period from the point of departure to the destination. The user's position is continuously updated through the GPS sensor (or other sensors) and spoken directions are provided as and when they are necessary.

Currently, navigation (e.g. in Google Maps) will often be performed from a mobile device such as a smartphone or tablet. These devices are generally battery powered, which can be limiting for particularly long navigation sessions, or in situations where the user's device is low on power. The consequences of running out of power during an active navigation session can be very significant for the user, especially if they are relying solely on the device's instructions to reach their destination.

### SUMMARY

One example embodiment of the techniques of this disclosure is a computer-implemented method in a mobile computing device, the method comprising: receiving, by one or more processors, an indication of an origin location and a destination location via a navigation application operating on the mobile computing device; generating, by the one or more processors, using the navigation application, a navigation route based on the origin location and the destination location, the navigation route including indications of one or more maneuvers required to be performed by a user; comparing, by the one or more processors, a remaining battery power level associated with the mobile computing device to a predicted processing power required for the navigation application to perform one or more functions related to the navigation route; and causing, by the one or more processors, the navigation application to operate in a power-saving mode based on the comparison, wherein operating the navigation application in the power-saving mode includes temporarily suspending at least one of the one or more functions related to the navigation route.

Another example embodiment of the techniques of this disclosure is a mobile computing device, comprising: one or more processors; and a computer-readable memory, which may be non-transitory, coupled to the one or more processors and storing instructions thereon that, when executed by the one or more processors, cause the mobile computing device to: receive an indication of an origin location and a destination location via a navigation application operating on the mobile computing device; generate, using the navigation application, a navigation route based on the origin location and the destination location, the navigation route including indications of one or more maneuvers required to be performed by a user; compare a remaining battery power level associated with the mobile computing device to a predicted processing power required for the navigation application to perform one or more functions related to the navigation route; and cause the navigation application to operate in a power-saving mode based on the comparison, wherein operating the navigation application in the power-saving mode includes temporarily suspending at least one of the one or more functions related to the navigation route.

Yet another example embodiment of the techniques of this disclosure is a computer-readable memory which is optionally non-transitory coupled to one or more processors and storing instructions thereon that, when executed by the one or more processors, cause the one or more processors to: receive an indication of an origin location and a destination location via a navigation application operating on a mobile computing device; generate, using the navigation application, a navigation route based on the origin location and the destination location, the navigation route including indications of one or more maneuvers required to be performed by a user; compare a remaining battery power level associated with the mobile computing device to a predicted processing power required for the navigation application to perform one or more functions related to the navigation route; and cause the navigation application to operate in a power-saving mode based on the comparison, wherein operating the navigation application in the power-saving mode includes temporarily suspending at least one of the one or more functions related to the navigation route.

### BRIEF DESCRIPTION OF THE DRAWINGS

FIG. 1 illustrates an example environment in which the techniques of the present disclosure can be used for saving power during a navigation session;

FIG. 2 is a block diagram of an example electronic device and an example head unit that can operate in the system of FIG. 1;

FIGS. 3A and 3B are example displays of a navigation application operating in a power-saving mode; and

FIG. 4 is a flow diagram of an example method for saving power during a navigation session, which can be implemented in a computing device.

### DETAILED DESCRIPTION

### Overview

The methods and systems of the present disclosure involve temporarily suspending a navigation session executing on a smartphone, tablet, wearable, or otherwise battery-powered device during periods when there is expected to be little or no user action required, in order to save battery power. Specifically, power may be saved by detecting portions of a route which require little oversight from the navigation system, such as long stretches of highway, and entering a power-saving mode of the navigation application during these portions of the route. In some examples, the user may manually select the power-saving mode, while in other examples, the navigation application may enter the power-saving mode automatically based on detecting remaining battery power below a threshold battery power threshold (which may be pre-set or specified by the user), or based on determining that the remaining battery power will not be sufficient for full-power navigation for the user's entire trip (i.e., based on the length and/or complexity of the trip).

For instance, while in the power-saving mode, the navigation application may stop refreshing coordinates used for navigation or traffic updates, or may stop displaying a map or updating the user's location on the map. In some examples, while in the power-saving mode, the navigation application may offload these tasks to another nearby mobile device (e.g., a mobile device associated with a passenger in the same vehicle) with more remaining battery power. Navigation can then be resumed after a specific amount of time (i.e., a calculated amount of time remaining until the next turn), in response to a triggering event (e.g., in response to detecting changes in the environment, detecting large changes in the location of the mobile device, and/or detecting that the mobile computing device has performed a maneuver, by accelerometers, gyrometers, or other motion sensors), or manually resumed by a user. Additionally, in some examples, navigation can be periodically (e.g., every five minutes, every ten minutes, etc.) resumed for short periods of time to check that the mobile computing device is still on track along the navigation route, and then suspended upon confirming that the mobile computing device is still on track along the navigation route.

Advantageously, by suspending a resource-intensive navigation session for certain periods during a longer trip, power and other resources of the mobile computing device may be conserved, allowing the mobile computing device to use the saved power and other resources for other applications, and ensuring that the user is able to reach the end of their trip without their mobile computing device running out of power. The power-saving mode may be particularly useful for users who are traveling with no way to charge the battery of their mobile computing device. For instance, the power-saving mode may ensure that users without charging cords, users in older vehicles or otherwise vehicles without charging ports, or users who are running, walking, or bicycling, are able to follow the navigation route to the end of their trip without their mobile computing device running out of power.

### Example Computing Environment

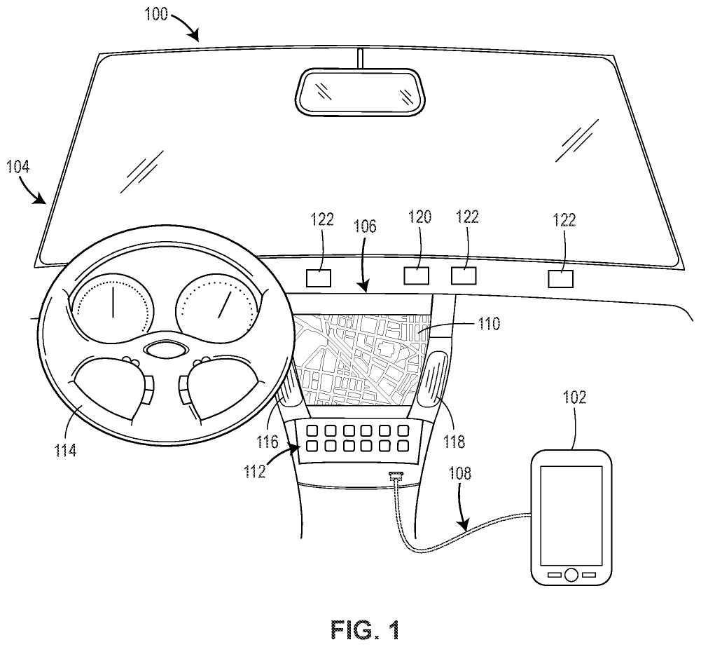

Referring to FIG. 1, an example environment 100 in which the techniques outlined above can be implemented includes an electronic device 102a and a vehicle 104 with a head unit 106. The electronic device 102a (also called a “mobile computing device” or a “mobile device” herein) may be a smart phone, tablet computer, wearable computer, etc. The electronic device 102a communicates with the head unit 106 of the vehicle 104 via a communication link 108, which may be wired (e.g., Universal Serial Bus (USB)) or wireless (e.g., Bluetooth, Wi-Fi Direct). The electronic device 102a also can communicate with various content providers, servers, etc. via a wireless communication network.

In operation, the electronic device 102a provides the head unit 106 with information related to navigation, which may include digital map images, text, and audio. The head unit 106 displays this information via a display 110. The display 110 in some implementations is a touchscreen and includes a software keyboard for entering text input, which may include the name or address of a destination, point of origin, etc. Another type of the display 110 can be as a relatively sophisticated screen provided along with a non-touch input device, such as a rotary controller, for example, or a separate touch pad. In general, the display 110 need not be capable of displaying both text and images. A head unit in another vehicle can include, for example, a simple display only capable of displaying alphanumeric characters on one or several lines.

The head unit 106 can include hardware input controls such as buttons, knobs, etc. These controls can be disposed on the head unit 106 or elsewhere in the vehicle 104. For example, the vehicle 104 in FIG. 1 includes navigation controls 112 on the head unit 106 as well as steering wheel controls 114 communicatively coupled to the head unit 106. The controls 112 and 114 can be mapped to a variety of navigation control functions on the electronic device 102a. The controls 112 and 114 in some implementations also can be used for entering alphanumeric characters.

The vehicle 104 can also include audio input and output components, such as a microphone 116 and a speaker 118. The microphone 116 may be configured to capture voice input from a user, while the speaker 118 may be configured to communicate navigation-related information with the user. Similar to the hardware controls 112 and 114, the microphone 116 and speaker 118 can be disposed directly on the head unit 106 or elsewhere in the vehicle 104. Additionally, the vehicle 104 can include other appropriate sensors 120, such as, for example, image sensors, which can also be disposed directly on the head unit 106 or elsewhere in the vehicle 104, and which may be configured to capture other types of input from the user (e.g., gesture commands). The vehicle 104 may also include one or more internal light indicators 122.

Of course, in some embodiments, the electronic device 102a may include some or all of the features of the head unit 106. That is, the electronic device 102a may include a display, a keyboard, hardware input controls such as buttons, knobs, etc., navigation controls, audio input and output components, various sensors, and/or lights, etc., such as those described with respect to the head unit 106. Moreover, in some embodiments, the electronic device 102a may perform some or all of the functions of the head unit 106, e.g., communicating/displaying information related to navigation, etc. Accordingly, in some embodiments an electronic device such as electronic device 102a may replace the head unit 106 described herein, i.e., some embodiments may not include a head unit at all.

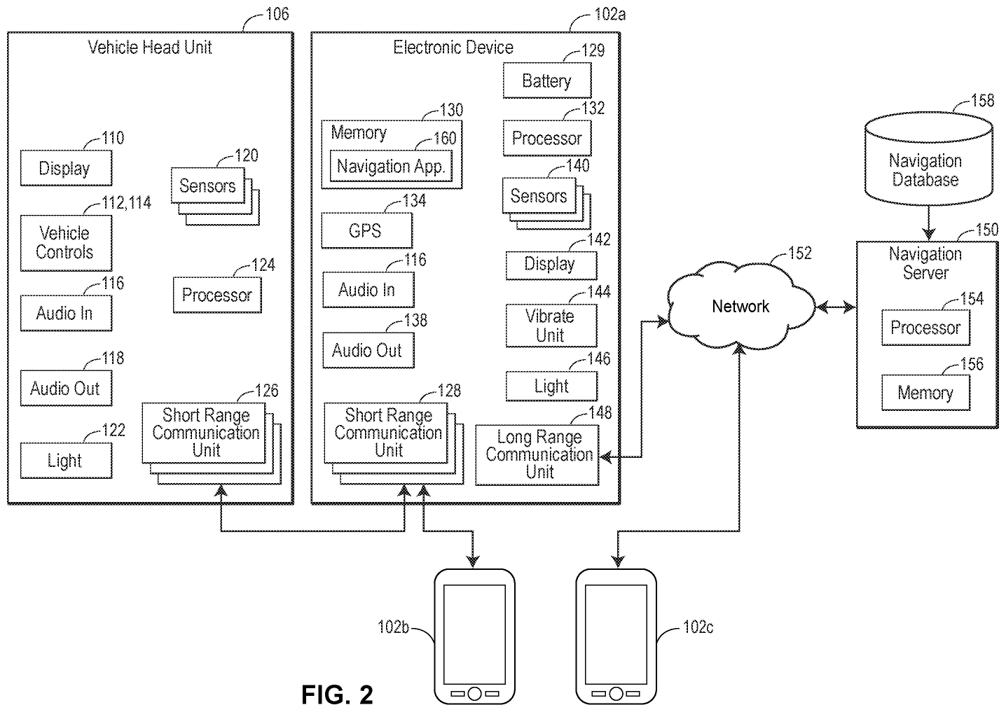

An example implementation of the electronic device 102a and head unit 106 is illustrated with reference to FIG. 2. As shown in FIG. 2, the electronic device 102a may further communicate with any number of other similar electronic devices 102b and 102c. While the electronic device 102a is described in greater depth, both of the electronic devices 102b and 102c are operatively the same as the electronic device 102a. As discussed above, the head unit 106 includes a display 110, hardware controls 112, 114, an audio input unit 116, and an audio output unit 118, one or more sensors 120, and an internal light 122. The head unit 106 may also include a processor 124 and one or several short-range communication units 126.

The set of sensors 120 can include, for example, a global positioning system (GPS) module to determine the current position of the vehicle in which the head unit 106 is installed, an inertial measurement unit (IMU) to measure the speed, acceleration, and current orientation of the vehicle, a barometer to determine the altitude of the vehicle, an image sensor configured to recognize responsive gestures made by a vehicle operator, etc. Although FIG. 2 depicts the set of sensors 120 inside the head unit 106, it is noted that the sensors 120 need not be integral components of the head unit 106. Rather, a vehicle can include any number of sensors in various locations, and the head unit 14 can receive data from these sensors during operation. Moreover, some or all of the sensors may be disposed at electronic device 102a, or otherwise communicatively connected to the electronic device 102a.

Depending on the implementation, the processor 124 can be a general-purpose processor that executes instructions stored on a computer-reader memory (not shown) or an application-specific integrated circuit (ASIC) that implements the functionality of the head unit 106. In any case, the processor 124 can operate to format, send, receive and/or process communication between the head unit 106 to the electronic device 102a, display map images and/or notifications via the display 110, play audio notifications/communications via the audio output 118, etc.

A short-range communication unit 126 allows the head unit 106 to communicate with the electronic device 102a. The short-range communication unit 126 may support wired or wireless communications, such as USB, Bluetooth, Wi-Fi Direct, Near Field Communication (NFC), etc. Similarly, the electronic device 102a can include a short-range communication unit 128 for communicating with the head unit 106 and with other electronic devices 102b. Similar to the short-range communication unit 126, the short-range communication unit 128 can support one or more communication schemes such as USB, Bluetooth, Wi-Fi Direct, etc.

The electronic device 102a can also include a battery power source 129, a memory 130, one or more processors 132, a positioning module such as a GPS unit 134, an audio input unit 136, and an audio output unit 138, one or more sensors 140, a display 142, a vibrate unit 144, and a light source 146 (e.g., an LED). The battery power source 129 may store power that is used by the electronic device 102a to perform processing, data gathering, and other functions. The memory 130, one or more processors 132, positioning module such as a GPS unit 134, audio input unit 136, and audio output unit 138, one or more sensors 140, display 142, vibrate unit 144, and light source 146 (e.g., an LED) may operate similarly to analogous components described as part of the head unit 106, and may in some instances be included only in the electronic device 102a. Furthermore, the electronic device 102a can include a long-range communication unit 148 to, e.g., communicate with another electronic device 102c, and/or transmit data to and receive data from a navigation server 150 via, e.g., a 3G cellular network, a 4G cellular network, an LTE cellular network, a Wi-Fi network, or any other suitable network 152. The navigation server 152 may include a processor 154 and a memory 156, and may be configured to access navigation-related data from one or more navigation databases 158.

Furthermore, the memory 130 can store instructions of a navigation application 160. The navigation application 160 can include compiled instructions and/or instructions in any suitable programmable language interpretable at runtime, and executes on the one or more processors 132. Generally, the navigation application generates, or receives from the navigation server 150, a route directing a user from an origin location to a destination location selected by the user. The route may be a vehicle route (e.g., for a user traveling in an automobile, boat, motorcycle, snowmobile, all-terrain vehicle, etc.), or a running, walking, or bicycling route. As one example, the route can include a sequence of steps, each describing a route segment (e.g., name or number of the road, distance, travel time, speed limit) and a maneuver (e.g., left turn, merge right, proceed straight) to access the next route segment. The navigation application 160 may also provide information about points of interest (POIs) along the route, as well as other information relevant to the user.

Additionally, the navigation application 160 may perform one or more functions related to the navigation route. For instance, these functions may include generating audio signals (e.g., via audio output 118 or 138) associated with the navigation route. Other functions related to the navigation route may include, for instance, displaying a map display associated with the navigation route and/or updating a graphical indication of a location associated with the mobile computing device on the map display associated with the navigation route (e.g., via a user interface display 110 or 142). Moreover, functions related to the navigation route may include, for example, refreshing sensor data indicative of the location associated with the mobile computing device (e.g., via the GPS 134). Furthermore, functions related to the navigation route may include, for instance, requesting updated traffic data associated with the navigation route (e.g., via a network, such as the network 152), and/or modifying the navigation route based on the updated traffic data.

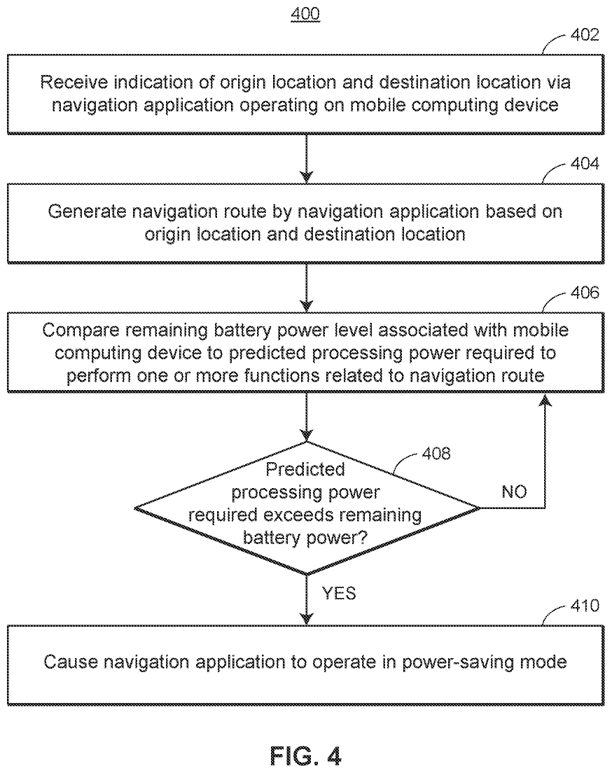

In some examples, the navigation application 160 may operate in a power-saving mode, as described in greater detail with respect to FIG. 4. In some examples, the navigation application 160 may operate in the power-saving mode based on input from a user, e.g., indicating that the user prefers that the navigation application 160 operate in the power-saving mode. Additionally, in some examples, the navigation application 160 may determine when to enter (i.e., begin to operate in) the power-saving mode based on the remaining battery power stored by the battery power source 129. For instance, the navigation application 160 may compare the power stored by the battery power source 129 to a threshold battery power, and may operate in the power-saving mode based on the power stored by the battery power source 129 being below the threshold battery power.

As another example, the navigation application 160 may predict how much processing power is required to perform the functions related to the navigation route and may determine whether to operate in the power-saving mode based on the predicted power required to perform the functions related to the navigation route. For example, the navigation application 160 may predict the processing power required to perform the functions related to the navigation route based on factors such as the remaining duration of the navigation route, the remaining distance of the navigation route, the number of maneuvers required in the navigation route, and/or some weighted combination of these factors. Additionally or alternatively, the navigation application 160 may predict the processing power required to perform the functions related to the navigation route based on the battery power consumed by the navigation application 160 during the current navigation session prior to entering the power-saving mode, and/or historical data indicating the battery power consumed by the navigation application 160 during previous trips. Moreover, in some examples, navigation application 160 may predict the processing power required to perform the functions related to the navigation route based on factors including the make and model of the electronic device 102a, the operating system running on the electronic device 102a, the number of other applications installed on and/or running on the electronic device 102a, etc.

For instance, the navigation application 160 may compare the required processing power to the power stored by battery power source 129 in order to determine whether sufficient battery power remains for the navigation application 160 to perform the functions related to the navigation route In this example, if there is not sufficient battery power remaining for the navigation application 160 to perform all of the functions related to the navigation route, the navigation application 160 may operate in the power-saving mode. As another example, the navigation application 160 may determine whether to enter the power-saving mode using a machine learning model trained to identify instances in which operating in the power-saving mode is necessary or appropriate, i.e., based on factors such as the remaining battery power stored by the battery power source 129 and characteristics of the navigation route, such as the number and frequency of maneuvers during the route, and/or otherwise the complexity of the route, e.g., as determined based on factors such as traffic levels, road conditions, weather, time of day, requirements to change lanes, etc., that may make the navigation route or portions of the navigation route more difficult to navigate for the user.

In any case, when operating in the power-saving mode, the navigation application 160 may temporarily suspend at least one of the one or more functions related to the navigation route in order to save battery power. Prior to or upon suspending functions related to the navigation route, the navigation application 160 may save, store, or cache an indication of the state of the navigation route in the memory 130.

In particular, the navigation application 160 may temporarily suspend various functions related to the navigation route at times when little to no guidance is required to ensure than the user successfully follows the route, i.e., to save power by not expending battery power for navigation functions that are less needed by the user.

In some examples, the navigation application 160 may periodically (e.g., every five minutes, every ten minutes, etc.) resume one or more of these suspended functions in order to ensure that the user is still successfully following the route. For instance, the navigation application 160 may periodically refresh GPS data associated with the electronic device 102a and compare it to a previous or anticipated state of the navigation route stored in the memory 130 to confirm that the user is still following the navigation route. Upon confirming that the user is still successfully following the route, the navigation application 160 may again suspend such resumed functions.

Moreover, in some examples, the navigation application 160 may resume these suspended functions at times when more guidance is required to ensure that the user successfully follows the route. For example, the navigation application 160 may temporarily suspend various functions related to the navigation route, such as displaying and updating the navigation map, refreshing location data, refreshing traffic data, etc., between maneuvers when there is a great distance or a long time until the next maneuver (e.g., above a threshold distance or time) and/or during less complex portions of the navigation route, and may resume these functions when the distance or time until the next maneuver decreases (e.g., below a threshold distance or time) and/or when the navigation route becomes more complex. For example, when the navigation application 160 predicts that the next maneuver will be required to be performed by the user in 30 minutes, the navigation application 160 may temporarily suspend various functions related to the navigation route for 25 minutes, and resume performing these functions when the next maneuver is imminent, i.e., when the next maneuver will be required to be performed by the user in five minutes.

Furthermore, in some examples, the navigation application 160 may resume these suspended functions based on a triggering event, such as determining that the user has performed a maneuver that is not part of the route, or determining that the location associated with the electronic device 102a is greater than a threshold distance from a previously determined location or from a predicted or expected location based on the elapsed time since the location associated with the electronic device 102a was last determined. In some examples, the navigation application 160 may determine that a maneuver has been performed by the user or determine the location associated with the electronic device 102a based on periodically resuming the function of refreshing GPS data indicative of the location associated with the mobile computing device, e.g., as discussed above. Additionally, in some examples, the navigation application 160 may determine that a maneuver has been performed by the user or determine the location associated with the electronic device 102a based on other methods of determining mobile device location, e.g., based on a location associated with a cell tower from which the electronic device 102a receives a signal, and/or based on data from other sensors 140, such as, e.g., accelerometers and/or gyroscopes of the electronic device 102a.

Moreover, the navigation application 160 may resume these suspended functions based on determining that the electronic device 102a is connected to an external power source, or based on receiving input from the user (e.g., via a user interface display 110 or 142, or via an audio input 116 or 136) indicating that the user prefers that the suspended functions be resumed. In any case, when the navigation application 160 resumes any suspended functions, the navigation application 160 may access a previously stored state of the navigation route from the memory 130 and update it, i.e., so that the entire navigation route does not need to be recomputed when the suspended functions are resumed.

Furthermore, in some examples, the navigation application 160 may hand off one or more functions related to the navigation route to other mobile computing devices 102b and/or 102c based on the remaining battery power associated with each of the mobile computing devices 102a, 102b, 102c. For instance, during a vehicle trip in which the mobile computing devices 102a and 102b and/or 102c are present in the same vehicle (e.g., a mobile computing device associated with the driver of the vehicle, and one or more mobile computing devices associated with various passengers of the vehicle), and the mobile computing device 102a is low on power while the mobile computing devices 102b and 102c have more power remaining, the navigation application 160 running on the mobile computing device 102a may suspend a particular function related to the navigation route and send a signal handing off the processing related to that function to another computing device, such as, e.g., the head unit 106 (e.g., via the short range communication unit 128 of the mobile computing device 102a and via the short range communication unit 126 of the head unit 106), or to another mobile computing device, such as the mobile computing device 102b (e.g., via the short range communication unit 128) or the mobile computing device 102c (e.g., via the long range communication unit 148 and network 152). In other implementations, the mobile computing device 102a may transmit the signal handing off the processing related to the particular function to a remote server that communicates with the mobile computing device 102b or 102c. Thus, one of the other mobile computing devices 102b or 102c may perform the processing associated with the particular function (e.g., refreshing sensor data indicative of the location associated with the mobile computing device, requesting updated traffic data associated with the navigation route, etc.) and send the results of the processing to the mobile computing device 102a (e.g., via the short range communication unit 128 and/or the long range communication unit 148). In this way, the navigation application 160 may conserve the remaining power of the battery power source 129 but maintain certain functions related to the navigation route, e.g., by offloading the processing of these functions to another mobile computing device 102b or 102c.

The mobile computing device 102a may detect the other mobile computing devices 102b, 102c within proximity of the mobile computing device 102a by receiving a broadcast, via the short range communication unit 128 or the long rang communication unit 148, from one of the other mobile computing device 102b, 102c. For example, the mobile computing device 102b may broadcast a Bluetooth message encoded with the identity of the mobile computing device 102b. The mobile computing device 102a may monitor for discoverable devices on frequencies associated with the Bluetooth protocol to identify the mobile computing device 102b.

### Example Display of a Navigation Application Operating in a Power-Saving Mode

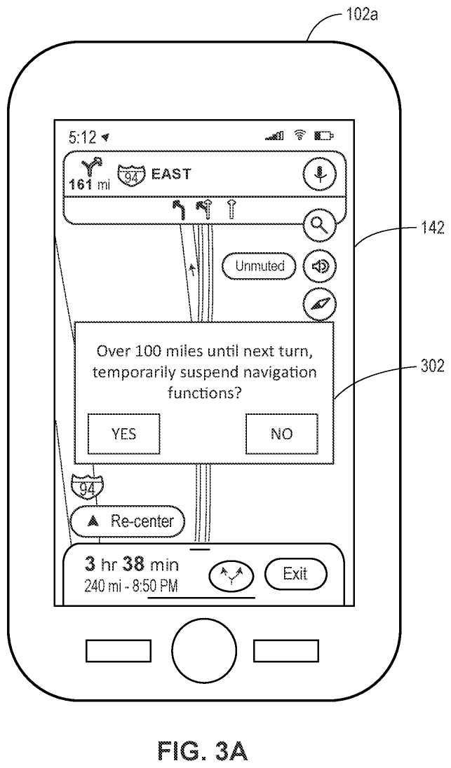

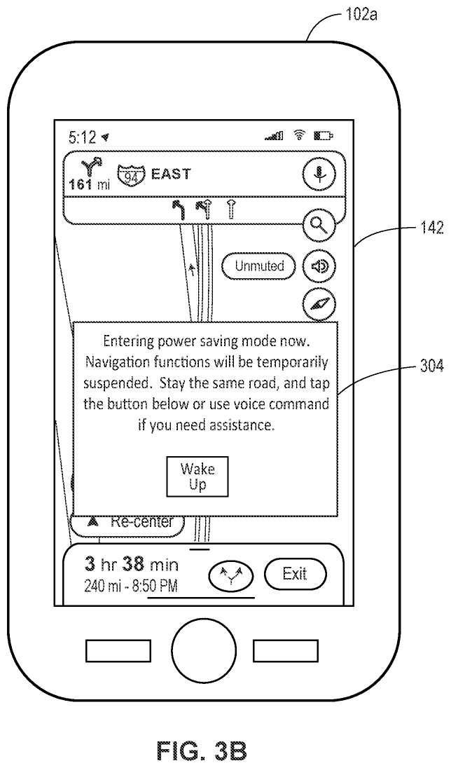

FIGS. 3A and 3B are example displays of a navigation application (e.g., the navigation application 160) operating in a power-saving mode. As discussed above, while operating in the power-saving mode, the navigation application 160 may temporarily suspend various functions related to the navigation route at times when little to no guidance is required to ensure than the user successfully follows the route. For example, FIG. 3A illustrates an example user interface display 142 of an electronic device 102a, displaying a navigation route generated by the navigation application 160, and a notification 302 indicating that there are more than 100 miles until the next maneuver and requesting to temporarily suspend one or more functions related to the navigation route. Based on receiving permission from the user or from another user, such as a passenger, acting on behalf of the user (302, “YES”), e.g., by receiving touch input indicating permission from the user or passenger via the user interface display 142 of the electronic device 102a, the navigation application 160 may temporarily suspend one or more functions related to the navigation route in order to save power. Additionally, in some examples, the electronic device 102a may receive a voice command indicating permission from the user via audio input 116 or 136, and the navigation application 160 may temporarily suspend one or more functions related to the navigation route based on the voice command. In contrast, if the user denies permission (302, “NO”) via the user interface display 142 of the electronic device 102a (or by voice command via the audio input 116 or 136), the navigation application 160 may continue to operate the one or more functions related to the navigation route.

Furthermore, as shown in FIG. 3B, once the user provides permission, the navigation application 160 may provide a notification 304 that the one or more functions related to the navigation route will be temporarily suspended. In particular, as shown in FIG. 3B, the navigation application may indicate, via the notification 304, that the user should continue to proceed along the same road while the navigation functions are suspended, and that the user may request assistance, or resume the suspended functions, via touch and/or voice command (e.g., by tapping the “Wake up” command from notification 304, or by voice command via the audio input 116 or 136).

### Example Method for Saving Power During a Navigation Application

FIG. 4 illustrates a flow diagram of an example method 400 for saving power during a navigation session. The method may be implemented in a set of instructions stored on a computer-readable memory (e.g., memory 130) and executable at one or more processors (e.g., processors 132) of a mobile computing device (e.g., the electronic device 102a). For example, the method can be implemented by a navigation application (e.g., the navigation application 160) executing or operating on the mobile computing device (e.g., electronic device 102a).

At block 402, an indication of an origin location and a destination location may be received via the navigation application. For instance, a user of the mobile computing device may provide the origin location and the destination location as inputs via a user interface display (e.g., display 110, or display 142).

At block 404, a navigation route may be generated using the navigation application based on the origin location and the destination location. For instance, the navigation route may include indications of one or more maneuvers required to be performed by a user to complete the navigation route from the origin location to the destination location. For example, the one or more maneuvers required to be performed by a user may include one or more of a walking maneuver, a bicycling maneuver, making a vehicle turn, or entering or exiting a public transit or ride share vehicle. In some examples, a single navigation route may include multiple different types of maneuvers required to be performed by the user. For instance, the route may require that a user walk several blocks on one road, turn right, walk several more blocks to a bus stop, train station, subway station, etc., enter a public transit vehicle such as a bus, train, subway, etc., and eventually exit the public transit vehicle and walk several more blocks in order to complete the navigation route. In other examples, the navigation route may include only one type of maneuver, i.e., a series of bicycle turns, or a series of vehicle turns, that the user is required to make to complete the navigation route.

At block 406, a remaining battery power level associated with the mobile computing device may be compared to a predicted processing power required for the navigation application to perform one or more functions related to the navigation route. For instance, functions related to the navigation route may include generating audio signals (e.g., via audio output 118 or 138) associated with the navigation route. Additionally, functions related to the navigation route may include, for instance, displaying a map display associated with the navigation route and/or updating a graphical indication of a location associated with the mobile computing device on the map display associated with the navigation route (e.g., via a user interface display 110 or 142). Moreover, functions related to the navigation route may include, for example, refreshing sensor data indicative of the location associated with the mobile computing device (e.g., via the GPS 134). Furthermore, functions related to the navigation route may include, for instance, requesting updated traffic data associated with the navigation route (e.g., via a network, such as the network 152), and/or modifying the navigation route based on the updated traffic data.

Predicting the processing power required to perform the functions related to the navigation route may be based on factors such as the remaining duration of the navigation route, the remaining distance of the navigation route, the number of maneuvers required in the navigation route, and/or some weighted combination of these factors. Additionally or alternatively, predicting the processing power required to perform the functions related to the navigation route may be based on the battery power consumed by the navigation application during the current navigation session prior to entering the power-saving mode, and/or historical data indicating the battery power consumed by the navigation application during previous trips. Moreover, in some examples, predicting the processing power required to perform the functions related to the navigation route may be based on factors including the make and model of the electronic device 102a, the operating system running on the electronic device 102a, the number of other applications installed on and/or running on the electronic device 102a, etc.

In any case, if the predicted processing power required for the navigation application to perform the one or more functions related to the navigation route does not exceed the remaining battery power (block 408, NO), block 406 may be repeated, e.g., periodically (e.g., every minute, every five minutes, every ten minutes, etc.), or as the navigation route or the functions related to the navigation route to be performed are updated. For instance, even if the remaining battery power level associated with the mobile computing device is initially sufficient for the navigation application to perform the functions related to the navigation route, the remaining battery power level associated with the mobile computing device may be depleted by other applications (e.g., music applications, web browsing applications, camera applications, etc.) executing or operating on the mobile computing device, so repeating block 406 may be used to determine whether the remaining battery power level associated with the mobile computing device remains sufficient to perform the functions related to the navigation route.

If the predicted processing power required for the navigation application to perform one or more functions related to the navigation route exceeds the remaining battery power associated with the mobile computing device (block 408, YES), the navigation application may operate in a power-saving mode (block 410). In some examples, even if the predicted processing power required for the navigation application to perform the one or more functions related to the navigation route does not exceed the remaining battery power (block 408, NO), the navigation may operate in the power-saving mode based on input (e.g., via the user interface display 110 or 142, or via the audio input 116 or 136) from the user including a request to operate in the power-saving mode.

Moreover, in some examples, block 408 may additionally or alternatively include determining whether to enter the power-saving mode using a machine learning model trained to identify instances in which operating in the power-saving mode is necessary or appropriate, i.e., based on factors such as the remaining battery power stored by the battery power source of the mobile computing device and characteristics of the navigation route, such as the number and frequency of maneuvers during the route, and/or otherwise the complexity of the route, e.g., as determined based on factors such as traffic levels, road conditions, weather, time of day, requirements to change lanes, etc., that may make the navigation route or portions of the navigation route more difficult to navigate for the user.

In any case, operating the navigation application in the power-saving mode may include temporarily suspending at least one of the one or more functions related to the navigation route. That is, as discussed above, functions related to the navigation route may include generating audio signals associated with the navigation route, displaying a map display associated with the navigation route, updating a graphical indication of a location associated with the mobile computing device on the map display associated with the navigation route, refreshing sensor data indicative of the location associated with the mobile computing device, requesting updated traffic data associated with the navigation route, and/or modifying the navigation route based on the updated traffic data. When the navigation application operates in the power-saving mode, any or all of these functions related to the navigation route may be temporarily suspended. Prior to or upon suspending any functions related to the navigation route, the navigation application may save, store, or otherwise cache a current version or state of the navigation route in a memory of the mobile computing device, which can be accessed upon resuming any temporarily suspended functions as needed so that the entire navigation route does not need to be recomputed when the suspended functions are resumed.

In some examples, permission from the user may be requested before entering the power-saving mode, or before temporarily suspending any functions related to the navigation route. If the user denies the navigation application permission, the power-saving mode may not be entered, and/or the functions related to the navigation route may not be suspended.

In some examples, the functions related to the navigation route that are temporarily suspended may be selected based on which functions related to the navigation route are the most processor-intensive, i.e., based on which functions have the highest predicted processing power. For instance, if displaying the map display associated with the navigation route is more processor-intensive than generating audio signals associated with the navigation route, in some examples, the navigation application may temporarily suspend displaying the map display associated with the navigation route, while continuing to generate audio signals associated with the navigation route, in the power-saving mode.

Additionally, in some examples, temporarily suspending the one or more functions related to the navigation route may be based on, e.g., a predicted amount of time and/or a predicted distance until a next maneuver is required to be performed by the user. For instance, while operating in the power-saving mode, the navigation application may temporarily suspend one or more of the functions related to the navigation route between maneuvers, i.e., when there is a great distance (i.e., greater than a threshold distance) between maneuvers, or a long time (e.g., greater than a threshold time) between maneuvers. For example, if there are 100 miles or 60 minutes between a maneuver and a subsequent maneuver of the navigation route (e.g., merging onto a highway, and subsequently exiting the highway after 100 miles or 60 minutes of proceeding along the highway), the navigation application may temporarily suspend one or more of the functions related to the navigation route between these maneuvers while operating in the power-saving mode. In contrast, if there is only one mile or five minutes between a maneuver and a subsequent maneuver of the navigation route (e.g., a first turn onto a first road segment, and another turn onto second road segment after a mile or five minutes of proceeding along the first road segment), the navigation application may continue to operate the functions related to the navigation route between these maneuvers even while operating in the power saving mode.

Moreover, in some examples, temporarily suspending the one or more functions related to the navigation route may be based on a complexity level associated with one or more portions of the navigation route. That is, for example, while operating in the power-saving mode, the navigation application may temporarily suspend one or more of the functions related to the navigation route during less complex portions of the navigation route. In contrast, during more complex portions of the navigation route, the navigation application may continue to operate these functions related to the navigation route even while operating in the power saving mode.

For instance, the complexity level associated with a portion of a navigation route may be based on, e.g., factors such as traffic levels, road conditions, weather, time of day, requirements to change lanes, etc., that may make a portion of the navigation route more difficult to navigate for the user. For example, a portion of a navigation route that includes higher levels of traffic, bumpy or steep road conditions, storms or precipitation, night time driving, and/or a higher number of lanes to cross may be considered more complex than a portion of a navigation route that includes lower levels of traffic, smooth road conditions, clear weather, day time driving, and/or a lower number of lanes to cross. Additionally, the complexity level associated with a portion of a navigation route may be based on rates at which historical users miss a particular turn. For instance, a portion of a route that includes a turn that has been frequently missed by historical users may be considered more complex than a portion of a route that includes turns that most historical users have made successfully. In some examples, machine learning methods may be used to generate a complexity score for various portions of a given route.

In some examples, temporarily suspending at least one of the one or more functions related to the navigation route may include temporarily handing off the one or more functions related to the navigation route from the mobile computing device to another mobile computing device (e.g., from electronic device 102a to other electronic devices 102b, 102c, etc.). For instance, during a vehicle trip in which multiple mobile computing devices are present in the same vehicle (e.g., a mobile computing device associated with the driver of the vehicle, and one or more mobile computing devices associated with various passengers of the vehicle), the processing or sensor functions related to the navigation route may be suspended on one mobile computing device and the processing associated with that particular function may be handed off to one or more of the other mobile computing devices in the same vehicle. For example, when the mobile computing device running the navigation application (e.g., the mobile computing device associated with the driver of the vehicle) is operating in the power-saving mode, the mobile computing device running the navigation application may cease a particular function (e.g., refreshing sensor data indicative of the location associated with the mobile computing device, requesting updated traffic data associated with the navigation route, etc.) and hand off the function to one of the other mobile computing devices in the vehicle (e.g., one of the mobile computing devices associated with a passenger of the vehicle). Thus, one of the other mobile computing devices in the vehicle may perform the processing associated with the particular function and send the results of the processing to the mobile computing device running the navigation application. In this way, the mobile computing device running the navigation application may conserve battery power but maintain the operation of the navigation application by offloading processing of various functions related to the navigation route to other mobile computing devices in the same vehicle. Of course, in some examples, the permission of users of the other mobile computing devices in the same vehicle may be required prior to the other mobile computing devices accepting the handoff of processing of the functions related to the navigation route.

Moreover, in some examples, operating the navigation application in the power-saving mode may include resuming any of the temporarily suspended functions related to the navigation route based on determining that that power-saving is no longer necessary. For instance, any of the temporarily suspended functions related to the navigation route may be resumed based on determining that the mobile computing device has been connected to a power source, i.e., indicating that the battery power of the mobile computing device is being replenished and no longer needs to be conserved. As another example, any of the temporarily suspended functions related to the navigation route may be resumed based on determining that remaining battery power of the mobile computing device is sufficient to perform these functions for the remaining duration of the navigation route (i.e., because the user of the power-saving mode has resulted in sufficient battery power to perform these functions for the remaining duration of the navigation route).

Additionally, in some examples, any of the temporarily suspended functions related to the navigation route may be resumed based on determining that the maneuver required to be performed by the user is imminent, e.g., based on determining that the predicted amount of time and/or predicted distance until the next maneuver is required to be performed by the user is less than a threshold predicted amount of time (e.g., one minute, two minutes, five minutes, etc.) and/or a threshold distance (e.g., half a mile, one mile, five miles, ten miles, etc.). For instance, if the next maneuver is required to be performed by the user in five minutes, or in five miles (or any threshold predicted amount of time or distance), one or more of the temporarily suspended functions related to the navigation route may be resumed, i.e., to ensure that the user is given sufficient warning to perform the next maneuver. Furthermore, in some examples, any of the temporarily suspended functions related to the navigation route may be resumed based on receiving a request from the user to resume any of the temporarily suspended functions related to the navigation route. For example, the user may provide input, (e.g., via the user interface display 110 or 142, or via a voice command received by the audio input 116 or 136) indicating that one or more of the temporarily suspended functions related to the navigation route should be resumed, and the navigation application may resume these functions based on the input from the user.

Furthermore, in some examples, operating the navigation application in the power-saving mode may include periodically (e.g., every five minutes, every ten minutes, etc.) resuming any of the temporarily suspended functions related to the navigation route in order to determine whether the user is still following the navigation route. For example, the function of refreshing GPS data indicative of the location associated with the mobile computing device may be periodically resumed in order to determine whether the user is still following the navigation route. In some examples, if the navigation application determines that the user is no longer following the navigation route, the resumed function may remain active and, in some examples, additional functions of the temporarily suspended functions may be resumed as well. In contrast, if the navigation application determines that the user is still following the navigation route, the resumed function may again be temporarily suspended.

Additionally, in some examples, any of the temporarily suspended functions related to the navigation route may be resumed based on determining that the user's route or location has varied significantly, e.g., varied significantly since the temporarily suspended functions were suspended, and/or varied significantly from a prediction made when the temporarily suspended functions were last enabled. For instance, any of the temporarily suspended functions related to the navigation route may be resumed based on determining that a maneuver has been performed by the user since the one or more functions related to the navigation route were temporarily suspended. For instance, in some examples, determining that a maneuver has been performed by the user may be based on periodically resuming the function of refreshing GPS data indicative of the location associated with the mobile computing device, e.g., as discussed above. Additionally, in some examples, determining that a maneuver has been performed by the user may be based on other methods of determining mobile device location, e.g., based on a location associated with a cell tower from which the mobile device receives a signal, and/or based on data from other sensors, such as, e.g., accelerometers and/or gyroscopes of the mobile computing device. For example, if one or more motion sensors of the mobile computing device detect motion indicative of a maneuver that is not part of the navigation route, i.e., indicating that the user may have made a wrong turn, one or more of the temporarily suspended functions related to the navigation route may be resumed.

As another example, any of the temporarily suspended functions related to the navigation route may be resumed based on determining that a location associated with the mobile computing device has changed by greater than a threshold distance since the one or more functions related to the navigation route were temporarily suspended. For instance, in some examples, determining the location associated with the mobile computing device (i.e., in order to determine that the location associated with the mobile computing device has changed by greater than a threshold distance since the one or more functions related to the navigation route were temporarily suspended) may be based on periodically resuming the function of refreshing GPS data indicative of the location associated with the mobile computing device, e.g., as discussed above. Additionally, in some examples, determining the location associated with the mobile computing device may be based on other methods of determining mobile device location, e.g., based on a location associated with a cell tower from which the mobile device receives a signal, and/or based on data from other sensors, such as, e.g., accelerometers and/or gyroscopes of the mobile computing device. For instance, if one or more motion or location sensors of the mobile computing device detect a current location of the mobile computing device that is greater than, e.g., 50 miles, 100 miles, etc., away from the location of the mobile computing device at the time when the one or more functions related to the navigation route were temporarily suspended, one or more of the temporarily suspended functions related to the navigation route may be resumed. As another example, if one or more motion or location sensors of the mobile computing device detect a current location of the mobile computing device, at a particular time, that is greater than, e.g., 5 miles, 10 miles, 25 miles, etc., away from the predicted location of the mobile computing device at that particular time based on the navigation route, i.e., indicating that the user may have veered from the navigation route, one or more of the temporarily suspended functions related to the navigation route may be resumed.

Furthermore, any of the temporarily suspended functions related to the navigation route may be resumed based on determining that an environment associated with the mobile computing device has changed since the one or more functions related to the navigation route were temporarily suspended (e.g., based on receiving sensor data associated with the environment of the mobile computing device). For example, if audio sensors of the mobile computing device detect levels or types of road noise, traffic noise, train noise, or other environmental sounds that are different than the levels or types of road noise, traffic noise, train noise, or other environmental sounds detected at the time when the one or more functions related to the navigation route were temporarily suspended, the environment of the user may have changed since the time when the one or more functions related to the navigation route were temporarily suspended, i.e., indicating that the user may have veered from the navigation route, or may otherwise require additional guidance to complete the navigation route. Accordingly, one or more of the temporarily suspended functions related to the navigation route may be resumed.

In any case, when the navigation application resumes a suspended function, the navigation application may access a previously stored state of the navigation route from the memory of the mobile computing device, i.e., so that the entire navigation route does not need to be recomputed when the suspended functions are resumed. For example, if displaying the map display associated with the navigation route is temporarily suspended, the navigation application may access a previously stored state of the navigation route from the memory of the mobile computing device when resuming displaying the map display associated with the navigation route.

### ADDITIONAL CONSIDERATIONS

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

A hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for establishing communication sessions related to navigation through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method in a mobile computing device, the method comprising:
receiving, by one or more processors, an indication of an origin location and a destination location via a navigation application operating on the mobile computing device;
generating, by the one or more processors, using the navigation application, a navigation route based on the origin location and the destination location, the navigation route including indications of one or more maneuvers required to be performed by a user;
comparing, by the one or more processors, a remaining battery power level associated with the mobile computing device to a predicted processing power required for the navigation application to perform one or more functions related to the navigation route; and
causing, by the one or more processors, the navigation application to operate in a power-saving mode based on the comparison, wherein operating the navigation application in the power-saving mode includes temporarily suspending at least one of the one or more functions related to the navigation route.

2. The computer-implemented method of claim 1, wherein temporarily suspending the one or more functions related to the navigation route is based on one or more of a predicted amount of time or a predicted distance until a next maneuver, of the one or more maneuvers, is required to be performed by the user.

3. The computer-implemented method of claim 1, wherein the one or more maneuvers required to be performed by a user include at least one of:
(i) a walking maneuver;
(ii) a biking maneuver;
(iii) making a vehicle turn; or
(iv) entering or exiting a public transit or ride share vehicle.

4. The computer-implemented method of claim 1, wherein temporarily suspending the one or more functions related to the navigation route is based on a complexity level associated with one or more portions of the navigation route.

5. The computer-implemented method of claim 1, wherein the one or more functions related to the navigation route include at least one of:
(i) displaying, via a user interface of the mobile computing device, a map display associated with the navigation route;
(ii) refreshing, by the one or more processors, sensor data indicative of a location associated with the mobile computing device;
(iii) updating, via the user interface of the mobile computing device, a graphical indication of a location associated with the mobile computing device on the map display associated with the navigation route;
(iv) requesting, by the one or more processors, via a network, updated traffic data associated with the navigation route; or
(v) modifying, by the one or more processors, the navigation route based on the updated traffic data.

6. The computer-implemented method of claim 1, wherein operating the navigation application in the power-saving mode includes resuming any of the temporarily suspended functions related to the navigation route based on one or more of:
(i) determining, by the one or more processors, that the mobile computing device has been connected to a power source;
(ii) determining, by the one or more processors, that the predicted amount of time until the next maneuver is required to be performed by the user is less than a threshold predicted amount of time;
(iii) receiving, by the one or more processors, a request to resume any of the temporarily suspended functions related to the navigation route;
(iv) receiving, by the one or more processors, sensor data indicating that a maneuver has been performed by the user since the one or more functions related to the navigation route were temporarily suspended;
(v) receiving, by the one or more processors, sensor data indicating that an environment associated with the mobile computing device has changed since the one or more functions related to the navigation route were temporarily suspended;
(vi) receiving, by the one or more processors, sensor data indicating that a location associated with the mobile computing device has changed by greater than a threshold distance since the one or more functions related to the navigation route were temporarily suspended; or
(vii) determining, by the one or more processors, that the remaining battery power level associated with the mobile computing device exceeds a predicted processing power required for the navigation application to perform one or more functions related to the navigation route.

7. The computer-implemented method of claim 1, wherein temporarily suspending at least one of the one or more functions related to the navigation route includes temporarily handing off the one or more functions related to the navigation route from the mobile computing device to another mobile computing device.

8. A mobile computing device, comprising:
one or more processors; and
a computer-readable memory coupled to the one or more processors and storing instructions thereon that, when executed by the one or more processors, cause the mobile computing device to:
receive an indication of an origin location and a destination location via a navigation application operating on the mobile computing device;
generate, using the navigation application, a navigation route based on the origin location and the destination location, the navigation route including indications of one or more maneuvers required to be performed by a user;
compare a remaining battery power level associated with the mobile computing device to a predicted processing power required for the navigation application to perform one or more functions related to the navigation route; and
cause the navigation application to operate in a power-saving mode based on the comparison, wherein operating the navigation application in the power-saving mode includes temporarily suspending at least one of the one or more functions related to the navigation route.

9. The mobile computing device of claim 8, wherein the instructions cause the mobile computing device to temporarily suspend the one or more functions related to the navigation route based on one or more of a predicted amount of time or a predicted distance until a next maneuver, of the one or more maneuvers, is required to be performed by the user.

10. The mobile computing device of claim 8, wherein the one or more maneuvers required to be performed by a user include at least one of:
(i) a walking maneuver;
(ii) a biking maneuver;
(iii) making a vehicle turn; or
(iv) entering or exiting a public transit or ride share vehicle.

11. The mobile computing device of claim 8, wherein the instructions cause the mobile computing device to temporarily suspend the one or more functions related to the navigation route based on a complexity level associated with one or more portions of the navigation route.

12. The mobile computing device of claim 8, wherein the one or more functions related to the navigation route include at least one of:
(i) displaying, via a user interface of the mobile computing device, a map display associated with the navigation route;
(ii) refreshing sensor data indicative of a location associated with the mobile computing device;
(iii) updating, via the user interface of the mobile computing device, a graphical indication of a location associated with the mobile computing device on the map display associated with the navigation route;
(iv) requesting, via a network, updated traffic data associated with the navigation route; or
(v) modifying the navigation route based on the updated traffic data.

13. The mobile computing device of claim 8, wherein the instructions causing the mobile computing device to operate the navigation application in the power-saving mode include instructions for resuming any of the temporarily suspended functions related to the navigation route based on one or more of:
(i) determining that the mobile computing device has been connected to a power source;
(ii) determining that the predicted amount of time until the next maneuver is required to be performed by the user is less than a threshold predicted amount of time;
(iii) receiving a request to resume any of the temporarily suspended functions related to the navigation route;
(iv) receiving sensor data indicating that a maneuver has been performed by the user since the one or more functions related to the navigation route were temporarily suspended;
(v) receiving sensor data indicating that an environment associated with the mobile computing device has changed since the one or more functions related to the navigation route were temporarily suspended;
(vi) receiving sensor data indicating that a location associated with the mobile computing device has changed by greater than a threshold distance since the one or more functions related to the navigation route were temporarily suspended; or
(vii) determining that the remaining battery power level associated with the mobile computing device exceeds a predicted processing power required for the navigation application to perform one or more functions related to the navigation route.

14. The mobile computing device of claim 8, wherein the instructions causing the mobile computing device to temporarily suspend at least one of the one or more functions related to the navigation route include instructions for temporarily handing off the one or more functions related to the navigation route from the mobile computing device to another mobile computing device.

15. A non-transitory computer-readable memory coupled to one or more processors and storing instructions thereon that, when executed by the one or more processors, cause the one or more processors to:
receive an indication of an origin location and a destination location via a navigation application operating on a mobile computing device;
generate, using the navigation application, a navigation route based on the origin location and the destination location, the navigation route including indications of one or more maneuvers required to be performed by a user;
compare a remaining battery power level associated with the mobile computing device to a predicted processing power required for the navigation application to perform one or more functions related to the navigation route; and
cause the navigation application to operate in a power-saving mode based on the comparison, wherein operating the navigation application in the power-saving mode includes temporarily suspending at least one of the one or more functions related to the navigation route.

16. The computer-readable memory of claim 15, wherein the instructions cause the one or more processors to temporarily suspend the one or more functions related to the navigation route based on one or more of a predicted amount of time or a predicted distance until a next maneuver, of the one or more maneuvers, is required to be performed by the user.

17. The computer-readable memory of claim 15, wherein the one or more maneuvers required to be performed by a user include at least one of:
(i) a walking maneuver;
(ii) a biking maneuver;
(iii) making a vehicle turn; or
(iv) entering or exiting a public transit or ride share vehicle.

18. The computer-readable memory of claim 15, wherein the instructions cause the one or more processors to temporarily suspend the one or more functions related to the navigation route based on a complexity level associated with one or more portions of the navigation route.

19. The computer-readable memory of claim 15, wherein the one or more functions related to the navigation route include at least one of:
(i) displaying, via a user interface of the mobile computing device, a map display associated with the navigation route;
(ii) refreshing sensor data indicative of a location associated with the mobile computing device;
(iii) updating, via the user interface of the mobile computing device, a graphical indication of a location associated with the mobile computing device on the map display associated with the navigation route;
(iv) requesting, via a network, updated traffic data associated with the navigation route; or
(v) modifying the navigation route based on the updated traffic data.

20. The computer-readable memory of claim 15, wherein the instructions causing the one or more processors to operate the navigation application in the power-saving mode include instructions for resuming any of the temporarily suspended functions related to the navigation route based on one or more of:
(i) determining that the mobile computing device has been connected to a power source;
(ii) determining that the predicted amount of time until the next maneuver is required to be performed by the user is less than a threshold predicted amount of time;
(iii) receiving a request to resume any of the temporarily suspended functions related to the navigation route;
(iv) receiving sensor data indicating that a maneuver has been performed by the user since the one or more functions related to the navigation route were temporarily suspended;
(v) receiving sensor data indicating that an environment associated with the mobile computing device has changed since the one or more functions related to the navigation route were temporarily suspended;
(vi) receiving sensor data indicating that a location associated with the mobile computing device has changed by greater than a threshold distance since the one or more functions related to the navigation route were temporarily suspended; or
(vii) determining, by the one or more processors, that the remaining battery power level associated with the mobile computing device exceeds a predicted processing power required for the navigation application to perform one or more functions related to the navigation route.

21. The computer readable memory of claim 8, wherein the instructions cause the one or more processors to temporarily suspend at least one of the one or more functions related to the navigation route by temporarily handing off the one or more functions related to the navigation route from the mobile computing device to another mobile computing device.
